(19) United States
(12) Patent Application Publication
(10) Pub. No.: US 2022/0288963 A1
(43) Pub. Date: Sep. 15, 2022

(54) Hygienic Disposable Sheet Wrap For Writing Utensils

(71) Applicant: Sylvia Owusu, Humble, TX (US)

(72) Inventor: Sylvia Owusu, Humble, TX (US)

(21) Appl. No.: 17/199,603

(22) Filed: Mar. 12, 2021

(51) Int. Cl. B43K 23/00

(52) U.S. Cl. CPC B43K 23/00

(57) ABSTRACT

Various embodiments of hygienic disposable sheet wraps for writing utensils are disclosed. A hygienic disposable sheet wrap may include a rectangular sheet of material, which may include an adhesive on at least one side thereof. A hygienic disposable sheet wraps may be perforated to define edges of separable single wrap sections. The perforations may include arcuate sections that may define a tab associated with each single wrap section. A hygienic disposable sheet wrap may be wrapped around a writing utensil. An outer single wrap section may be peeled away from the underlying portion of the rectangular sheet of material to which it may be adhered. This may be done by grasping and pulling the outer single wrap section. An outer single wrap section may be separated from an adjoining single wrap section by applying a pulling force to tear the perforations adjoining the two single wrap sections.

### BACKGROUND OF THE INVENTIONS

### 1. Field of the Inventions

The present inventions generally pertain to hygienic products, and more particularly to disposable hygienic sheet wraps for writing utensils.

### 2. Description of the Related Art

The COVID-19 pandemic has significantly impacted the way humans all over the globe live out their daily lives. From social distancing, to mask wearing, to constantly washing our hands and using hand sanitizers, the pandemic has greatly modified human behavior. The pandemic has also spurred innovation, some of which has focused on products and processes to help prevent the spread of the COVID-19 virus. For example, health and medical experts believe that the COVID-19 virus can survive on various surfaces for considerable periods of time. As such, one way COVID-19 is transmitted can be when someone infected with the virus touches a surface and transmits the virus to that surface, then another person, who has not been infected, touches the infected surface, which then results in that previously uninfected person becoming infected with the COVID-19 virus.

This surface-to-human transmission can occur with respect to a wide variety of surfaces, examples of which could be door handles, faucet handles, and telephones. Another example can occur at public places of business where pens or other writing utensils are made available to the public for various reasons, such as to fill out a form. As such, a need has been identified for a way to eliminate or reduce transmission of the COVID-19 virus through multiple people using the same writing utensils. Various patents exist that relate to some type of cover or sleeve for a writing utensil or medical device, such as: U.S. Pat. No. 3,738,479 to Sato entitled “Disposable Rigid Thermometer Probe Cover;” U.S. Pat. No. 4,142,631 to Brandriff entitled “Sterile Thermometer Sheath;” U.S. Pat. No. 5,328,368 to Lansing et al. entitled “Dental Cure Light Cover;” U.S. Pat. No. 10,328,743 to Marshall et al. entitled “Writing Instrument Attachment;” U.S. Design Pat. No. D728,110 to Corbett, III et al. entitled “Sterile Sheath For Wearable Medical Imaging Instrument;” United States Patent Application Publication No. 2014/0130298 to Vassel entitled “Novel Pen or Pencil Sleeve Device;” Chinese Patent No. CN201677613U U to Fangfang entitled “Plastic Pencil Sleeve;” and Chinese Patent No. CN2806166 U Y to Peng entitled “Pencil Sleeve.” None of these items, however, satisfy the present need as described above.

There is thus a need for hygienic disposable sheet wraps for writing utensils to combat the spread of viruses such as COVID-19. As will become apparent from the description and explanation set forth below, the present inventions address the above-identified need by providing hygienic disposable sheet wraps for writing utensils.

### SUMMARY OF THE INVENTIONS

In one aspect, the present inventions may include a hygienic disposable sheet wrap for writing utensils comprising: a generally rectangular sheet of material, the sheet of material including a first single wrap section disposed adjacent a left edge of the rectangular sheet of material and at least one successive single wrap section disposed to the right of the first single wrap section, the first single wrap section having a left edge, an upper edge, a lower edge and a right perforated edge, the right perforated edge including a tab, the at least one successive single wrap section including a left perforated edge, an upper edge, and a lower edge, and the right perforated edge of the first single wrap section being connected to the left perforated edge of the at least one successive single wrap section. Another feature of this aspect of the present inventions may be that an adhesive is adhered to a side of the rectangular sheet of material. Another feature of this aspect of the present inventions may be that the left edge of the first single wrap section is generally perpendicular to the upper edge of the first single wrap section, the left edge of the first single wrap section is generally perpendicular to the lower edge of the first single wrap section, and the left edge of the first single wrap section is generally parallel to right perforated edge of the first single wrap section. Another feature of this aspect of the present inventions may be that the right perforated edge of the first single wrap section includes an upper perforated section and a lower perforated section, the upper and lower perforated sections being generally parallel to the left edge of the first single wrap section; and the right perforated edge further includes a curved perforated section disposed between a lower end of the upper perforated section and an upper end of the lower perforated section, the curved perforated section defining the tab. Another feature of this aspect of the present inventions may be that the curved perforated section is in the form of an arc having an apex, the distance between the apex of the curved perforated section and the left edge of the first single wrap section being greater than the distance between the left edge of the first single wrap section and the upper and lower perforated sections of the first single wrap section. Another feature of this aspect of the present inventions may be that the apex is located generally equidistant between the upper edge of the single wrap section and the lower edge of the single wrap section. Another feature of this aspect of the present inventions may be that the left perforated edge of the at least one successive single wrap section is generally parallel to a right perforated edge of the at least one successive single wrap section. Another feature of this aspect of the present inventions may be that the left perforated edge of the at least one successive single wrap section includes an upper left perforated section, a lower left perforated section, and a left arcuate perforated section disposed between and joining the upper left perforated section and the lower left perforated section; and a right perforated edge of the at least one successive single wrap section includes an upper right perforated section, a lower right perforated section, and a right arcuate perforated section disposed between and joining the upper right perforated section and the lower right perforated section. Another feature of this aspect of the present inventions may be that the left arcuate perforated section extends inwardly from the upper left perforated section and the lower left perforated section to form a concave indention. Another feature of this aspect of the present inventions may be that the right arcuate perforated section extends outwardly from the upper right perforated section and the lower right perforated section to form a convex tab.

In another aspect, the present inventions may include a hygienic disposable sheet wrap for writing utensils comprising: a generally rectangular sheet of material having an adhesive on one side thereof, the generally rectangular sheet of material having a left edge, an upper edge and a lower edge, the upper edge and the lower edge being generally perpendicular to the left edge, the upper edge and the lower edge being generally parallel to each other, the generally rectangular sheet of material including a plurality of sets of perforations defining adjoining edges of a plurality of single wrap sections, each single wrap section including a tab, and each set of perforations defining a line of perforations disposed between adjoining single wrap sections. Another feature of this aspect of the present inventions may be that each line of perforations is generally parallel to the left edge of the generally rectangular sheet of material and generally perpendicular to the upper and lower edges of the generally rectangular sheet of material. Another feature of this aspect of the present inventions may be that each line of perforations includes an arcuate line of perforations defines the tab for one of the single wrap sections. Another feature of this aspect of the present inventions may be that each line of perforations includes an upper line of perforations, a lower line of perforations, and an arcuate line of perforations leading from a lower end of the upper line of perforations to an upper end of the lower line of perforations. Another feature of this aspect of the present inventions may be that each arcuate line of perforations defines an apex, the apex being located generally equidistant between the upper edge of the generally rectangular sheet of material and the lower edge of the generally rectangular sheet of material. Another feature of this aspect of the present inventions may be that each arcuate line of perforations defines the tab of one of the single wrap sections. Another feature of this aspect of the present inventions may be that each arcuate line of perforations extends outwardly away from the left edge of the generally rectangular sheet of material.

In yet another aspect, the present inventions may include a method of using a hygienic disposable sheet wrap on a writing utensil, the hygienic disposable sheet wrap comprising a generally rectangular sheet of material having an adhesive on one side of thereof, the generally rectangular sheet of material having a left edge, an upper edge and a lower edge, the upper edge and the lower edge being generally perpendicular to the left edge, the upper edge and the lower edge being generally parallel to each other, the generally rectangular sheet of material including a plurality of sets of perforations defining adjoining edges of a plurality of single wrap sections, each single wrap section includes a tab, and each set of perforations defining a line of perforations disposed between adjoining single wrap sections, the method comprising: wrapping the generally rectangular sheet of material around the writing utensil; and applying a pulling force to an outer single wrap section to sever the perforations between the outer single wrap section and an adjoining single wrap section. Another feature of this aspect of the present inventions may be that, after wrapping the generally rectangular sheet of material around the writing utensil, the method may further include peeling the outer single wrap section away from the underlying portion of the generally rectangular sheet of material to which the outer single wrap section is adhered. Another feature of this aspect of the present inventions may be that the method may further include grasping the tab on the outer single wrap section; and applying a pulling force to the tab to peel the outer single wrap section away from the generally rectangular sheet of material.

Other features, aspects and advantages of the present inventions will become apparent from the following discussion and detailed description.

### BRIEF DESCRIPTION OF THE DRAWINGS

FIG. 1 is a top view of a specific embodiment of a hygienic disposable sheet wrap for writing utensils constructed in accordance with one aspect of the present inventions.

FIG. 2 is a side view of the hygienic disposable sheet wrap for writing utensils shown in FIG. 1.

FIG. 2A is enlarged side view of a portion of the hygienic disposable sheet wrap for writing utensils shown in FIG. 2.

FIG. 3 is a top view of a single wrap section after it has been removed from the hygienic disposable sheet wrap for writing utensils shown in FIG. 1.

FIG. 4 is a perspective view of the hygienic disposable sheet wrap for writing utensils shown in FIG. 1 adhered to a pen with a single wrap section unrolled from around the pen for separation and removal after use.

FIG. 5 is a perspective view of the hygienic disposable sheet wrap for writing utensils shown in FIG. 1 adhered to a pen and ready to use.

FIG. 6 is a perspective view of the hygienic disposable sheet wrap for writing utensils shown in FIG. 1 adhered to a pencil and ready to use.

FIG. 7 is a perspective view of the hygienic disposable sheet wrap for writing utensils shown in FIG. 1 adhered to a stylus and ready to use.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

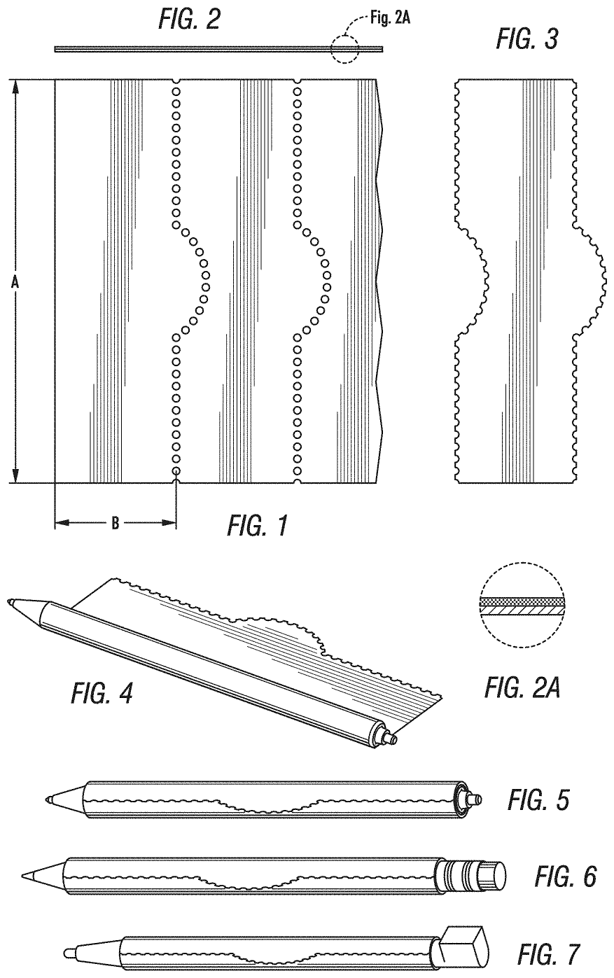

Referring to the drawings in detail, wherein like numerals denote identical elements throughout the several views, and referring initially to FIG. 1, there is shown a top view of a hygienic disposable sheet wrap for writing utensils 10. In a specific embodiment, as shown in FIGS. 2 and 2A, the sheet 10 may include a substrate 11 having an adhesive 13 adhered thereto. In a specific embodiment, the sheet 10 and/or substrate 11 may be formed from one or more flexible materials, non-limiting examples of which may include flexible materials formed from paper products, films, plastics, elastomers, fiber materials, and/or composites or laminates of any of the foregoing. In a specific embodiment, the sheet 10 may have a width A in the range of 4 to 6 inches.

In a specific embodiment, the hygienic disposable sheet 10 may comprise a plurality of single wrap sections 12, 14, and 16. As more fully discussed below, the shape of the first or left-most single wrap section 12 is different than the successive single wrap sections 14 and 16. In addition, it is noted that FIG. 1 does not show the entire sheet 10. It should be understood that the sheet 10 may include as many successive single wrap sections 14/16 as are desired to the right of the first or left-most single wrap section 12. In a specific embodiment, the left-most single wrap section 12 may have a left linear or straight edge 18, an upper linear or straight edge 20, a lower linear or straight edge 22, and a right perforated edge 24. In a specific embodiment, each of the upper edge 20 and the lower edge 22 may be generally perpendicular to the left edge 18.

In a specific embodiment, the right perforated edge 24 may include an upper perforated section 26 extending downwardly from the upper linear/straight edge 20, a lower perforated section 28 extending upwardly from the lower linear/straight edge 22, and a curved perforated section 30 disposed between the upper perforated section 26 and the lower perforated section 28. In a specific embodiment, the curved perforated section 30 may define a tab 32, the purpose of which will be explained below.

In a specific embodiment, the upper perforated section 26 and the lower perforated section 28 may be generally parallel to the left linear/straight edge 18. In a specific embodiment, the upper perforated section 26 may be disposed in generally perpendicular relationship to the upper linear/straight edge 20. In a specific embodiment, the lower perforated section 28 may be disposed in generally perpendicular relationship to the lower linear/straight edge 22. In a specific embodiment, the upper perforated section 26 may be spaced apart from the left edge 18 by a distance B. In a specific embodiment, the lower perforated section 28 may be spaced apart from the left edge 18 by the distance B. In a specific embodiment, the distance B may be in the range of 1 to 1.5 inches.

In a specific embodiment, the curved perforated section 30 may be in the form of an arc having an apex 34. In a specific embodiment, the distance between the apex 34 of the curved perforated section 30 and the left edge 18 may be greater than the distance B between the left edge 18, on the one hand, and the upper and lower perforated sections 26 and 28, on the other hand. In a specific embodiment, the apex 34 may be generally centered along the right perforated edge 24. In a specific embodiment, the apex 34 may be located generally equidistant between the upper edge 20 and the lower edge 22. In a specific embodiment, an upper end of the curved perforated section 30 may join to a lower end of the upper perforated section 26. In a specific embodiment, a lower end of the curved perforated section 30 may join to an upper end of the lower perforated section 28.

Having described the left-most single wrap section 12, each of the successive single wrap sections 14 and 16 to the right of the left-most single wrap section 12 will now be described. It is noted that an example of a single wrap section 14/16 is shown by itself in FIG. 3 after having been separated from the hygienic disposable sheet wrap 10. In comparing the left-most single wrap section 12 to the successive single wrap sections 14 and 16, it can be seen that the right side of the left-most single wrap section 12 and the right sides of the successive single wrap sections 14 and 16 are the same. However, the left side of the left-most single wrap section 12 and the left sides of the successive single wrap sections 14 and 16 are different.

Referring to FIG. 3, a representative successive single wrap section 14/16 is shown. In a specific embodiment, the successive single wrap section 14/16 may include a left perforated edge 36, a right perforated edge 38, an upper edge 40 and a lower edge 42. In a specific embodiment, the left perforated edge 36 and the right perforated edge 38 may be disposed in generally parallel relationship to one another.

In a specific embodiment, the left perforated edge 36 may include an upper left perforated section 44, a lower left perforated section 46, and a left arcuate perforated section 48 disposed between and joining the upper left perforated section 44 and the lower left perforated section 46. In a specific embodiment, the left arcuate perforated section 48 may extend inwardly from the upper left perforated section 44 and the lower left perforated section 46 to form a concave indention 49 along the left side of the successive single wrap section 14/16.

In a specific embodiment, the right perforated edge 38 may include an upper right perforated section 50, a lower right perforated section 52, and a right arcuate perforated section 54 disposed between and joining the upper right perforated section 50 and the lower right perforated section 52. In a specific embodiment, the right arcuate perforated section 54 may extend outwardly from the upper right perforated section 50 and the lower right perforated section 52 to form a convex tab 56 along the right side of the successive single wrap section 14/16. It is noted that the present inventions are not intended to be limited to any particular shape of tabs 32 or 56, but instead the present inventions are intended to encompass tabs 32/56 of any shape.

Referring now to FIG. 4, a pen 58 is shown with a disposable hygienic sheet wrap 10 wrapped therearound. To install the sheet 10 on the pen 58, the left straight edge 18 of the sheet 10 is positioned along the length of the pen 58 with the adhesive side 13 down, i.e., in contact with the pen 58. The sheet 10 is then completely wrapped around the pen 58 into the position as shown in FIG. 5. This is preferably done by someone whose hands are protected in a suitable manner (e.g., with gloves) so as to avoid contamination of the sheet 10. The pen 58 may then be used by a first user. At that point, before the pen 58 is placed back into circulation to be used again by the public, an outer single wrap section 60 is peeled away from the writing utensil as shown in FIG. 4 by grasping the tab 56. The single wrap section 60 is then separated from the remaining single wrap sections by tearing it off along the perforations as identified above, thereby exposing a clean sheet. At this point, the pen 58 is now covered by a clean and sterile hygienic sheet wrap that can be used by the public without the risk, or at least at reduced risk, of becoming infected with a virus, such as COVID-19. The same process can be used for a variety of writing utensils, such as a pencil 62 shown in FIG. 6, or a stylus 64 as shown in FIG. 7, for example. Uses of the utensil wrap 10 as described herein may include commercial, institutional and home settings for hygienic purposes. The wrap 10 may also be provided with individual logos or customized labels to meet customer needs.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims.

1. A hygienic disposable sheet wrap for writing utensils comprising:
a generally rectangular sheet of material,
the sheet of material including a first single wrap section disposed adjacent a left edge of the rectangular sheet of material and at least one successive single wrap section disposed to the right of the first single wrap section,
the first single wrap section having a left edge, an upper edge, a lower edge and a right perforated edge, the right perforated edge including a tab,
the at least one successive single wrap section including a left perforated edge, an upper edge, and a lower edge, and
the right perforated edge of the first single wrap section being connected to the left perforated edge of the at least one successive single wrap section.

2. The hygienic disposable sheet wrap for writing utensils of claim 1, wherein an adhesive is adhered to a side of the rectangular sheet of material.

3. The hygienic disposable sheet wrap for writing utensils of claim 1, wherein the left edge of the first single wrap section is generally perpendicular to the upper edge of the first single wrap section, the left edge of the first single wrap section is generally perpendicular to the lower edge of the first single wrap section, and the left edge of the first single wrap section is generally parallel to right perforated edge of the first single wrap section.

4. The hygienic disposable sheet wrap for writing utensils of claim 1, wherein:
the right perforated edge of the first single wrap section includes an upper perforated section and a lower perforated section, the upper and lower perforated sections being generally parallel to the left edge of the first single wrap section; and
the right perforated edge further includes a curved perforated section disposed between a lower end of the upper perforated section and an upper end of the lower perforated section, the curved perforated section defining the tab.

5. The hygienic disposable sheet wrap for writing utensils of claim 4, wherein the curved perforated section is in the form of an arc having an apex, the distance between the apex of the curved perforated section and the left edge of the first single wrap section being greater than the distance between the left edge of the first single wrap section and the upper and lower perforated sections of the first single wrap section.

6. The hygienic disposable sheet wrap for writing utensils of claim 5, wherein the apex is located generally equidistant between the upper edge of the single wrap section and the lower edge of the single wrap section.

7. The hygienic disposable sheet wrap for writing utensils of claim 1, wherein the left perforated edge of the at least one successive single wrap section is generally parallel to a right perforated edge of the at least one successive single wrap section.

8. The hygienic disposable sheet wrap for writing utensils of claim 1, wherein:
the left perforated edge of the at least one successive single wrap section includes an upper left perforated section, a lower left perforated section, and a left arcuate perforated section disposed between and joining the upper left perforated section and the lower left perforated section; and
a right perforated edge of the at least one successive single wrap section includes an upper right perforated section, a lower right perforated section, and a right arcuate perforated section disposed between and joining the upper right perforated section and the lower right perforated section.

9. The hygienic disposable sheet wrap for writing utensils of claim 8, wherein the left arcuate perforated section extends inwardly from the upper left perforated section and the lower left perforated section to form a concave indention.

10. The hygienic disposable sheet wrap for writing utensils of claim 8, wherein the right arcuate perforated section extends outwardly from the upper right perforated section and the lower right perforated section to form a convex tab.

11. A hygienic disposable sheet wrap for writing utensils comprising:
a generally rectangular sheet of material having an adhesive on one side thereof,
the generally rectangular sheet of material having a left edge, an upper edge and a lower edge, the upper edge and the lower edge being generally perpendicular to the left edge, the upper edge and the lower edge being generally parallel to each other,
the generally rectangular sheet of material including a plurality of sets of perforations defining adjoining edges of a plurality of single wrap sections,
each single wrap section including a tab, and
each set of perforations defining a line of perforations disposed between adjoining single wrap sections.

12. The hygienic disposable sheet wrap for writing utensils of claim 11, wherein each line of perforations is generally parallel to the left edge of the generally rectangular sheet of material and generally perpendicular to the upper and lower edges of the generally rectangular sheet of material.

13. The hygienic disposable sheet wrap for writing utensils of claim 11, wherein each line of perforations includes an arcuate line of perforations defines the tab for one of the single wrap sections.

14. The hygienic disposable sheet wrap for writing utensils of claim 11, wherein each line of perforations includes an upper line of perforations, a lower line of perforations, and an arcuate line of perforations leading from a lower end of the upper line of perforations to an upper end of the lower line of perforations.

15. The hygienic disposable sheet wrap for writing utensils of claim 14, wherein each arcuate line of perforations defines an apex, the apex being located generally equidistant between the upper edge of the generally rectangular sheet of material and the lower edge of the generally rectangular sheet of material.

16. The hygienic disposable sheet wrap for writing utensils of claim 14, wherein each arcuate line of perforations defines the tab of one of the single wrap sections.

17. The hygienic disposable sheet wrap for writing utensils of claim 14, wherein each arcuate line of perforations extends outwardly away from the left edge of the generally rectangular sheet of material.

18. A method of using a hygienic disposable sheet wrap on a writing utensil, the hygienic disposable sheet wrap comprising a generally rectangular sheet of material having an adhesive on one side of thereof, the generally rectangular sheet of material having a left edge, an upper edge and a lower edge, the upper edge and the lower edge being generally perpendicular to the left edge, the upper edge and the lower edge being generally parallel to each other, the generally rectangular sheet of material including a plurality of sets of perforations defining adjoining edges of a plurality of single wrap sections, each single wrap section includes a tab, and each set of perforations defining a line of perforations disposed between adjoining single wrap sections, the method comprising:
wrapping the generally rectangular sheet of material around the writing utensil; and
applying a pulling force to an outer single wrap section to sever the perforations between the outer single wrap section and an adjoining single wrap section.

19. The method of claim 18, further comprising, after wrapping the generally rectangular sheet of material around the writing utensil, peeling the outer single wrap section away from the underlying portion of the generally rectangular sheet of material to which the outer single wrap section is adhered.

20. The method of claim 19, further comprising:
grasping the tab on the outer single wrap section; and
applying a pulling force to the tab to peel the outer single wrap section away from the generally rectangular sheet of material.
